(19) United States
(12) Patent Application Publication
(10) Pub. No.: US 2024/0128032 A1
(43) Pub. Date: Apr. 18, 2024

(54) Self-Powered Smart Switch

(71) Applicant: Menlo Microsystems, Inc., Irvine, CA (US)

(72) Inventors: Pallab Midya, Palatine, IL (US); Yan-Fei Liu, Kingston (CA); Chris Giovanniello, Aliso Viejo, CA (US); Peter Maimone, Orange, CA (US); Mohammed Agamy, Niskayuna, NY (US)

(21) Appl. No.: 18/394,444

(22) Filed: Dec. 22, 2023

Related U.S. Application Data
(63) Continuation of application No. PCT/US2022/073114, filed on Jun. 23, 2022.
(60) Provisional application No. 63/215,168, filed on Jun. 25, 2021.

(51) Int. Cl. H01H 1/00; H01H 59/00; H01H 71/08

(52) U.S. Cl. CPC H01H 1/0036; H01H 59/0009; H01H 71/08; H01H 2071/008

(57) ABSTRACT

A switch device may comprise a micro-relay disposed between a first terminal and a second terminal. The micro-relay may be configured to selectively electrically couple the first terminal to the second terminal. The switch device may further comprise a bypass circuit configured to selectively divert at least a portion of electrical current flowing from the first terminal to the micro-relay, and direct the diverted electrical current to the second terminal. The switch device may further comprise an energy harvesting circuit configured to (i) withdraw a portion of energy flowing into the switch device, (ii) store the portion of energy in an energy storage device, and (iii) supplying the energy stored in the energy storage device to one or more components within the switch device.

### RELATED APPLICATION

This application is a continuation of International Application No. PCT/US2022/073114, which designated the United States and was filed on Jun. 23, 2022, published in English, which claims the benefit of U.S. Provisional Application No. 63/215,168, filed on Jun. 25, 2021. The entire teachings of the above application(s) are incorporated herein by reference.

### BACKGROUND

It is well known to use a mechanical switch to selectively direct electrical current from an electrical source to a load such as an electrical light. FIG. 1 shows an example of such an arrangement where a switch 10 is placed in series between an electrical source 12 and a load 14. The load 14 may be, for example, an overhead light in a building, the source 12 may be 110 VAC power in the building, and the switch 10 is used by an occupant of the building to turn the light on and off by physically manipulating the mechanical switch. The switch in this example is a two-terminal device, with terminals T1 and T2 shown. In some configurations, a third terminal (not shown) may be available for connecting to system ground (neutral).

In some situations, it may be desirable to replace the two-terminal mechanical switch 10 with an electrically-controllable switch. Such existing electrically-controllable switches may require power from an external source to operate, support, and control components within the device.

### SUMMARY

The described embodiments are directed to a two-terminal switching device that incorporates a micro-relay, e.g., a micro-electromechanical system (MEMS) device, configured to be situated in the path of a high wattage power source and a load. The two-terminal switching device can be used to selectively convey and/or interrupt power flowing from the power source to the load (i.e., to switch the load on or off). Example embodiments of the invention are configured to harvest energy from the primary active circuit (i.e., the circuit that the switching device is operatively controlling). A goal of the described embodiments is to have minimal effect on the load and the primary aspect of the circuit.

In one embodiment, the two-terminal device may be implemented as a smart switch, which selectively conveys electrical power from a source to a load based on an external input. The external input may be actuated through a wireless connection to the two-terminal device. In another embodiment, the two-terminal device may be implemented as a smart fuse, which interrupts power flowing from the source to the load for a predetermined amount of time when the load current exceeds a predetermined rated current.

Embodiments may implement an energy harvesting scheme, which occasionally takes a small amount of energy from the energy flow the two-terminal switching device is selectively controlling. The energy harvesting scheme is operated during both switch on mode (i.e., electrically conductive from terminal to terminal) and off mode (i.e., electrical isolation between terminals).

In the “on” mode, the micro-relay is turned off for one half cycle periodically (e.g., once per minute). During this half cycle, the voltage to the load is reduced and that voltage is used to charge an energy storage device (e.g., a capacitor). When the energy storage device reaches the desired voltage, a bypass switch is turned on and a series switch is turned off until the end of the half cycle of the AC mains voltage (i.e., the sourced voltage being controlled by the micro-relay). In the following half cycle the micro-relay is turned on until the storage capacitor needs to be recharged. The functionality of the bypass switch and the series switch are described in more detail herein.

In the “off” mode, the micro-relay and the bypass switch are always kept off. To charge the energy storage device the series switch is turned on which charges the energy storage device using the load current. When the energy storage device reaches the desired voltage the bypass switch is turned on and the series switch is turned off till the end of the half cycle of the AC mains voltage. In the following half cycle, the micro-relay is turned on until the energy storage device needs to be recharged. To prevent a high voltage from appearing across the load, the series switch is turned off after a determined amount of time. Since the AC mains voltage amplitude and frequency are known, limiting the on-time limits the amount of voltage and current at the load node in the off mode.

Characteristics of the described embodiments may include one or more of (i) a two-terminal switch device, (ii) that is self-contained, (iii) that uses a MEMS micro-relay to perform a switching function, (iv) that is electrically controlled, (v) that harvests energy from the active circuit being controlled by the switch, thereby facilitating a self-powered switch device, and (vi) has little to no effect on the load and the source (i.e., the primary aspect of the controlled circuit).

In one aspect, the invention may a switch device, comprising a micro-relay disposed between a first terminal and a second terminal. The micro-relay may selectively electrically couple the first terminal to the second terminal. The switch device may further comprise a bypass circuit that selectively diverts at least a portion of electrical current flowing from the first terminal to the micro-relay, and directs the diverted electrical current to the second terminal. The switch device may also comprise an energy harvesting circuit that (i) withdraws a portion of energy flowing into the switch device, (ii) stores the portion of energy in an energy storage device, and (iii) supplies the energy stored in the energy storage device to one or more components within the switch device.

In an embodiment, the first terminal may be coupled to a source of electrical current, and the second terminal may be coupled to a load that is a sink for electrical current. The switch device may further comprise a third terminal coupled to a neutral node associated with the source of electrical current and the load. A neutral switch may couple electrical current flowing from the micro-relay, away from the second terminal and to the third terminal. The switch device may further comprise a transformer that generates an actuating voltage for the micro-relay from the energy stored in the energy storage device. The micro-relay may be a MEMS device. The switch device may further comprise a wireless transceiver that conveys control information into the switch device and/or test point and/or diagnostic information out of the switch device.

In another aspect, the invention may be a current interruption device, comprising a micro-relay disposed between a first terminal and a second terminal. The micro-relay may selectively electrically couple the first terminal to the second terminal. The current interruption device may further comprise a current measurement circuit that measures current flowing through the micro-relay and generates a current signal that is indicative of the current flowing through the micro-relay. The current interruption device may further comprise a control component that opens the micro-relay when the current signal indicates that the current flowing through the micro-relay exceeds a threshold current value for a first amount of time. The current interruption device may further comprise an energy harvesting circuit that (i) withdraws a portion of energy flowing into the current interruption device, (ii) stores the portion of energy in an energy storage device, and (iii) supplies the energy stored in the energy storage device to one or more components within the current interruption device.

The first terminal may be coupled to a source of electrical current, and the second terminal may be coupled to a load that is a sink for electrical current. The current interruption device may further comprise a transformer that generates an actuating voltage for the micro-relay from the energy stored in the energy storage device. The current interruption device may further comprise a timer component that provides an indication of elapsed time to the control component. The control component may use the indication of elapsed time to determine the threshold amount of time. The control component may further close the micro-relay when a second amount of time has passed. The first amount of time and the second amount of time may be programmable by a user. The current interruption device may further comprise a wireless transceiver that conveys control information into the current interruption device and/or test point and/or diagnostic information out of the current interruption device.

In another aspect, the invention may be a method of controlling a flow of current between a first terminal and a second terminal, comprising selectively electrically coupling, using a micro-relay, the first terminal to the second terminal. The method may further comprise selectively diverting, using a bypass circuit, at least a portion of electrical current flowing from the first terminal to the micro-relay, and directing the diverted electrical current to the second terminal. The method may further comprise, with the use of an energy harvesting circuit, (i) withdrawing a portion of energy flowing into the micro-relay, (ii) storing the portion of energy in an energy storage device, and (iii) supplying the energy stored in the energy storage device to one or more components associated with the micro-relay.

The method may further comprise coupling, using a neutral switch, electrical current flowing from the micro-relay, away from the second terminal and to the third terminal. The method may further comprise conveying, with the use of a wireless transceiver, control information for operating the micro-relay and/or test point and/or diagnostic information associated with operation of the micro-relay

In another aspect, the invention may be a method of interrupting a flow of current between a first terminal and a second terminal, comprising selectively electrically coupling, using a micro-relay, the first terminal and the second terminal. The method may further comprise measuring, using a current measurement circuit, current flowing through the micro-relay, and generating a current signal that is indicative of the current flowing through the micro-relay. The method may further comprise opening, using a control component, the micro-relay when the current signal indicates that the current flowing through the micro-relay exceeds a threshold current value for a first amount of time. The method may further comprise, using an energy harvesting circuit, (i) withdrawing a portion of energy flowing into the micro-relay, (ii) storing the portion of energy in an energy storage device, and (iii) supplying the energy stored in the energy storage device to one or more components associated with the micro-relay.

The method may further comprise closing the micro-relay when a second amount of time has passed. The method may further comprise conveying, with a wireless transceiver, control information for operating the micro-relay and/or test point and/or diagnostic information associated with operation of the micro-relay.

### BRIEF DESCRIPTION OF THE DRAWINGS

The foregoing will be apparent from the following detailed description of example embodiments, as illustrated in the accompanying drawings in which like reference characters refer to the same parts throughout the different views. The drawings are not necessarily to scale, emphasis instead being placed upon illustrating embodiments.

FIG. 1 schematically illustrates an arrangement having a switch placed in series with an electrical source and a load according to the prior art.

FIG. 2 schematically illustrates a circuit with a MEMS-based device as the switch, an AC voltage source producing a cyclic voltage Vphase, and a load resistor LoadRes as the load according to one embodiment.

FIG. 3 schematically illustrates a circuit with an added bypass switch according to one embodiment.

FIG. 4 schematically illustrates a circuit with an added storage capacitor and series switch according to one embodiment.

FIG. 5 schematically illustrates a circuit with added components for a connection to a system neutral node according to one embodiment.

FIG. 6 schematically illustrates a three-terminal switching device in a neutral-available configuration according to one embodiment.

FIG. 7 schematically illustrates two-terminal switching device in a configuration that does not have an available neutral connection according to one embodiment.

FIG. 8 schematically illustrates a three-terminal switching device in a neutral-available configuration according to one embodiment.

FIGS. 9-12 schematically illustrate various waveforms associated with charging capacitor by energy harvesting in an example scenario without a neutral connection.

FIGS. 13 and 14 schematically illustrate waveforms associated with charging capacitor by energy harvesting in an example scenario with a neutral connection.

FIG. 15 schematically illustrates operational modes when the configuration does not have a neutral connection.

FIG. 16 schematically illustrates operational modes when the system configuration provides access to a neutral connection.

FIGS. 17 and 18 schematically illustrate state diagrams for configurations without a neutral connection available and with a neutral connection available, respectively.

FIGS. 19 and 20 schematically illustrate example embodiments for gate drive circuits for driving the embodiment of the switch implemented by a MEMS relay.

FIG. 21 schematically illustrates a gate drive circuit for driving an embodiment of the switch implemented by a stacked MEMS micro-relay.

FIG. 22 schematically illustrates a self-starting circuit configured to initially provide power to logic and MEMS gate drive circuits upon system power-up.

FIG. 23 schematically illustrates a circuit with a MEMS-based device as a fuse according to one embodiment.

### DETAILED DESCRIPTION

A description of example embodiments follows.

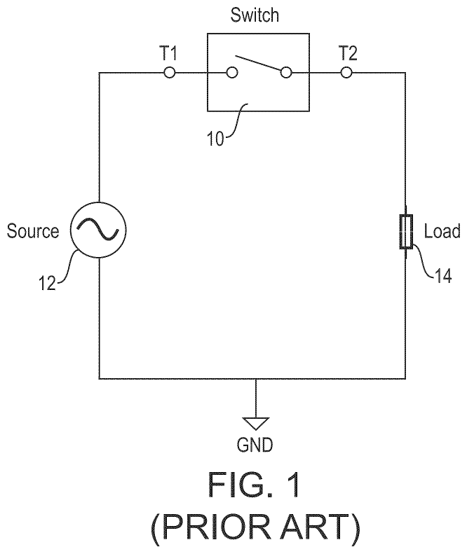

FIG. 1 shows an example of an arrangement having a switch 10 placed in series with an electrical source 12 and a load 14. The switch 10 may be used to selectively direct electrical current from the source 12 to the load 14.

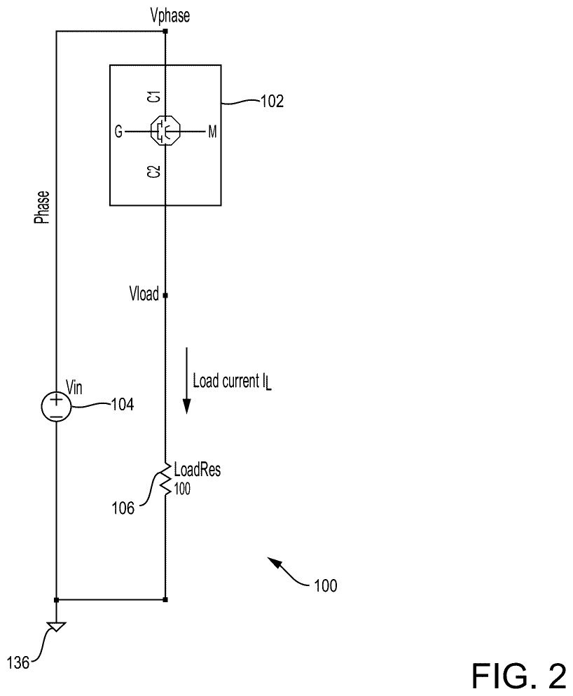

FIG. 2 shows a switch device 100 according to one embodiment, comprising a micro-electromechanical system (MEMS)-based device as the switch 102, an AC voltage source 104 producing a cyclic voltage Vphase, and a load resistor 106 as the load.

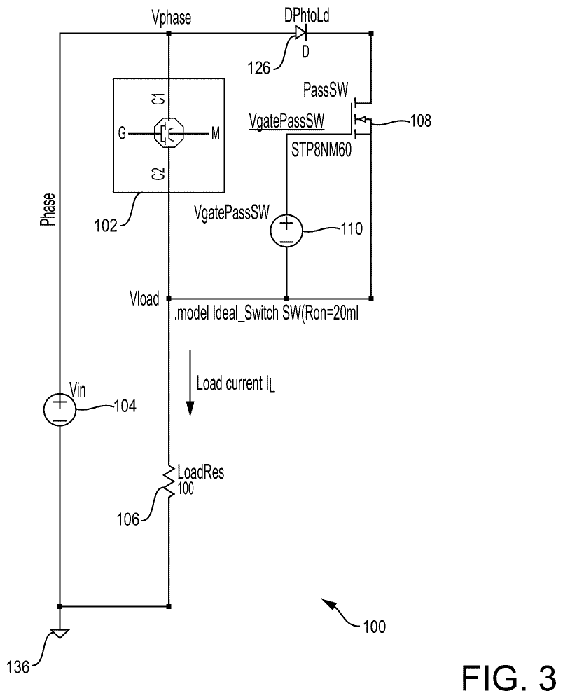

Repeatedly opening the MEMS micro-relay switch 102 while current is flowing through it may shorten the life of the switch 102. To mitigate this detrimental effect, an embodiment may add a bypass switch 108, as shown in the switch device 100 of FIG. 3. The bypass switch 108 diverts load current I_{L} from the switch 102 for a determined time immediately before opening the switch 102, so that when switch 102 is opened little or no current is flowing through the switch 102. Once the switch 102 is opened, the bypass switch 108 is turned off, thereby stopping the load current I_{L} from flowing.

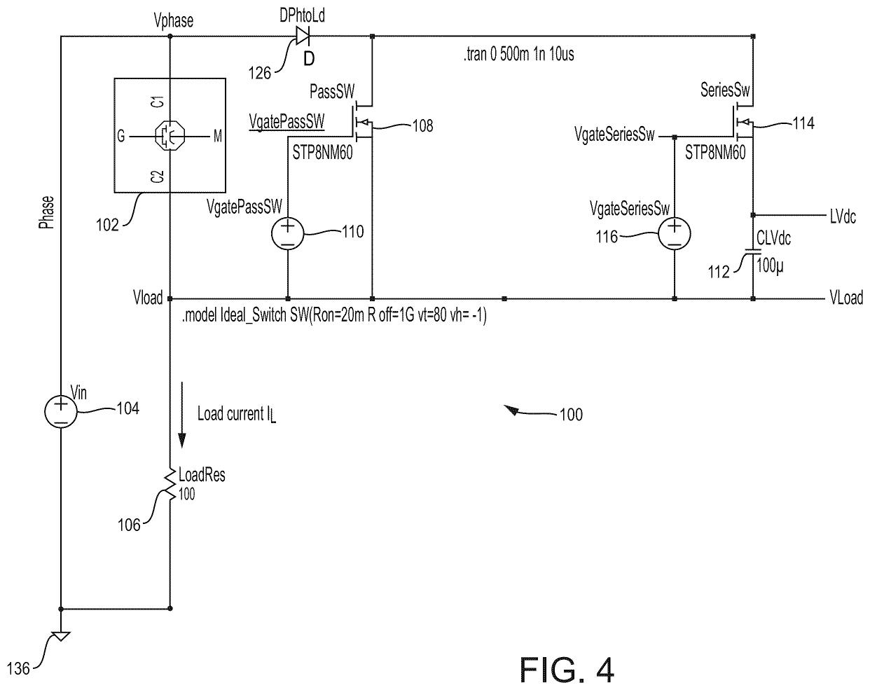

The bypass switch control voltage 110 in the example above turns the bypass switch 108 on and off. Control voltage 110 is generated by logic (not shown), which requires a low voltage source. The voltage source 104 cannot be used directly to provide this low voltage source, because in some embodiments the voltage source 104 may be a relatively high voltage (e.g., 110 VAC building voltage) providing electrical energy to, for example, a light source. Accordingly, a separate low voltage DC source is may be used. In the example embodiment below, a low voltage (LVdc) may be stored on a capacitor 112, as shown in the switching device of the embodiment of FIG. 4. An embodiment may use a series switch 114 to divert some of phase voltage Vphase from the voltage source 104 to charge the capacitor 112. A series switch control voltage 116 turns the series switch 114 on and off.

When switch 102 is in its “off” state (non-conductive), the voltage available across the capacitor 112 is essentially equal to the source voltage Vphase, i.e., the output of the voltage source Vin 104, since Vload is at ground potential with load current I_{L}=0. During the cycle of the voltage source 104, the voltage will eventually be at the desired low voltage LVdc value (e.g., 5V). At that point in the voltage source cycle, the series switch 114 is turned on for a short portion of the voltage source cycle, which facilitates charging the capacitor 112 to the desired low voltage LVdc voltage value. When the switch 102 is in its off state, however, the load voltage Vload is expected to be at or near zero volts, and a safety issue may exist if this is not the case. Turning the series switch 114 on for a short portion of the voltage source cycle may cause the load voltage Vload to rise above safe levels. Accordingly, the amount of time the series switch 114 is turned on, and when in the voltage source cycle it is turned on, is controlled to avoid causing the load voltage Vload to increase to unsafe levels while the switch 102 is in its off state.

When the switch 102 is its “on” state (i.e., conductive), the voltage at node Vload is at or near the voltage source voltage Vphase because the switch 102 exhibits very low on resistance (e.g., 10 milli-ohm). When the voltage at node Vload is at or near the voltage source voltage Vphase, there is little or no voltage available to charge the capacitor 112. Accordingly, when the switch 102 is in its “on” state, the switch 102 needs to be turned off briefly to create a voltage drop from the voltage source voltage Vphase to the voltage at node Vload to provide an available voltage to charge the capacitor 112. The amount of time switch 102 is turned off can be small so that the resulting effect is nearly imperceptible to a user who expects the switch to be in a constant “on” state.

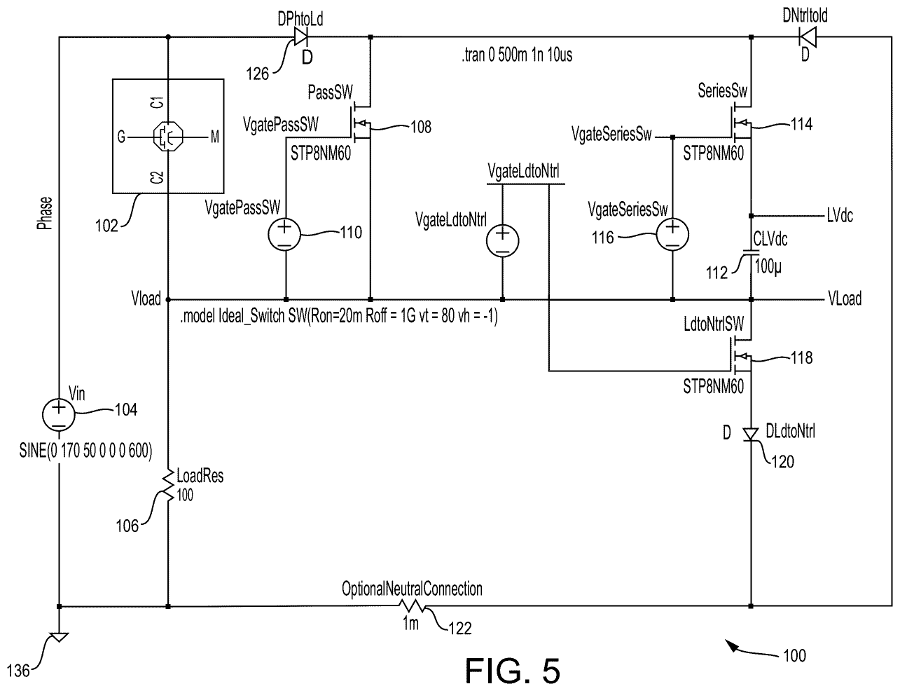

In some configurations of the switch device 100, a neutral connection to the load/source system may be available. In those cases, the additional components of the embodiment shown in FIG. 5 may be utilized. A neutral switch 118, along with a diode 120 and a resistor 122, provide an additional path to ground from the node Vload (i.e., in addition to the path through the load 106), by which the capacitor 112 may be charged without causing a potentially unsafe voltage at the node Vload when the switch 102 is in its off state. A neutral switch control voltage 128 turns the neutrals switch 118 on and off.

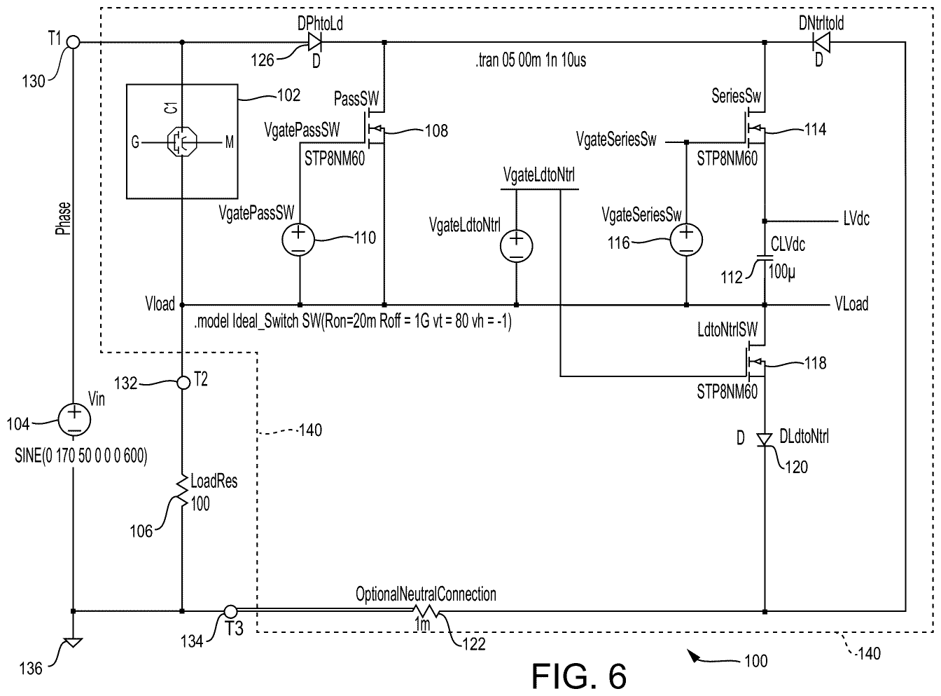

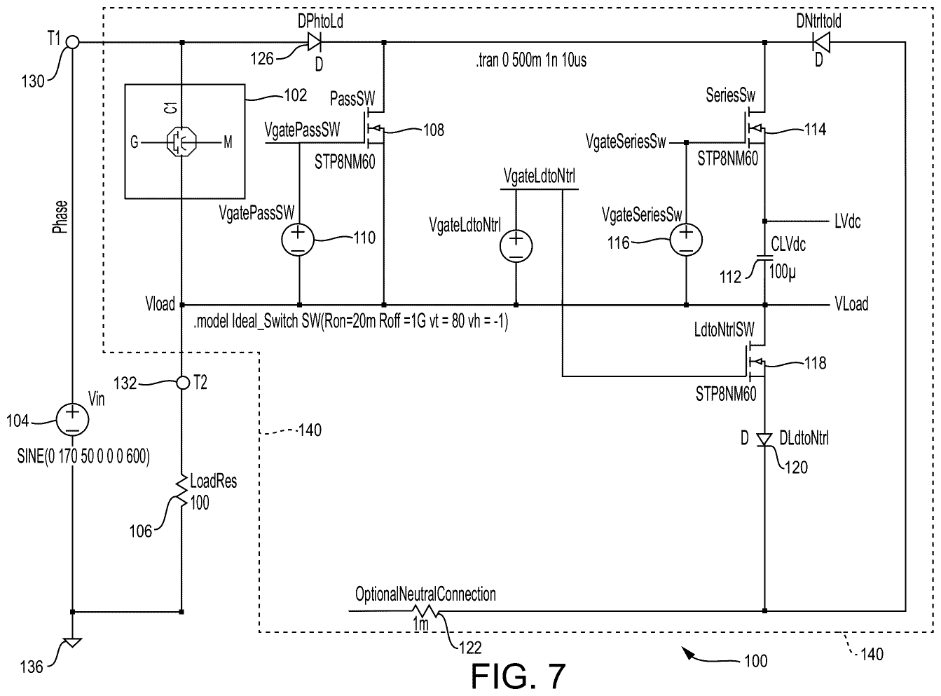

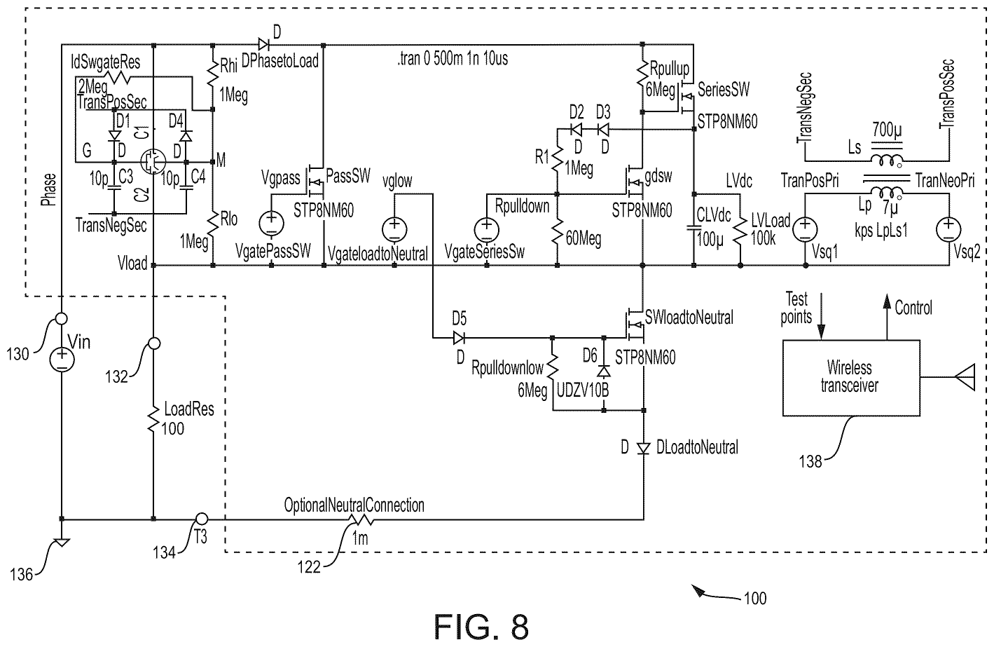

In one embodiment, a common set of components 140 may be implemented in both a configuration where a neutral connection is available and a configuration where no neutral configuration is available. For example, FIGS. 6 and 8 show three-terminal switching devices in a neutral-available configuration, with a first terminal T1 130 electrically coupled to the voltage source 104, a second terminal T2 132 electrically coupled to the load 106, and a third terminal T3 134 electrically coupled to system ground 136. FIG. 7 illustrates a two-terminal switching device in a configuration that does not have an available neutral connection. For this configuration, only the first terminal T1 130 and the second terminal T2 132 have connections in the system, i.e., to the voltage source 104 and the load 106, respectively. In both configurations shown in FIGS. 6 and 7, the set of common components are shown within the dashed delineating box.

FIG. 8 illustrates an embodiment that further comprises a wireless transceiver 138 that receives test point and other diagnostic information from the switch device 100 and transmits that information through an antenna to a receiver external to the device 100. The wireless transceiver 138 may also receive control information from a source external to the device 100 and distribute that control information to control logic within the switch device 100. The control information may be used, for example, to turn the MEMS micro-relay 102 on and off. The wireless transceiver may comprise any wireless protocol transceiver known in the art, including, but not limited to, Bluetooth, Bluetooth Low Energy (BLE), and ZigBee, among others.

The switch 102, which in the example embodiment is a MEMS switch, needs an actuation voltage (e.g., 90V) to turn the switch 102 on and off. An embodiment may utilize a transformer (e.g., 2 mm×2 mm×1 mm) to produce the required actuation voltage from the logic-level voltages available in the two-terminal switching device.

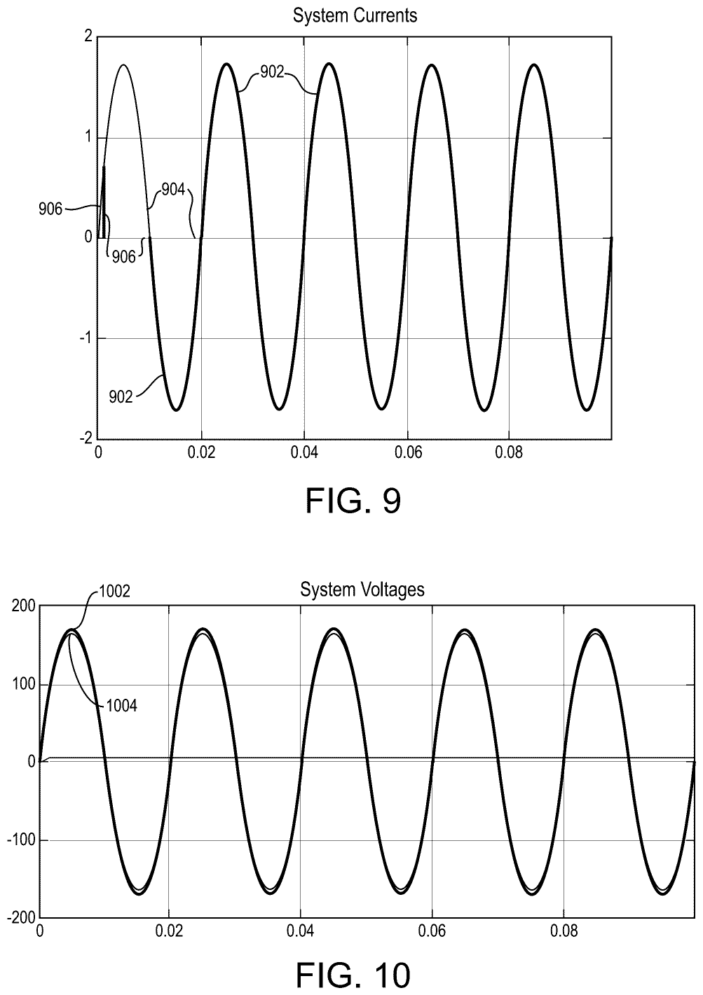

FIGS. 9-12 show various waveforms associated with charging the capacitor 112 by energy harvesting in an example scenario without a neutral connection.

FIG. 9 shows various system currents, where the blue waveform 902 depicts current through the switch 102, the green waveform 904 depicts current through the bypass switch 108, and the red waveform 906 depicts current through the series switch 114.

FIG. 10 shows charging of the capacitor 112 while the switch 102 is in its “on” state. A difference in amplitude can be seen between the blue trace 1002 (Vphase) and the red trace 1004 (Vload) during a short time at the beginning of the waveform. This small difference is due to a drop across a diode 126, the series switch 114, and the capacitor 112 while the switch 102 is briefly off and the series switch 114 is briefly on.

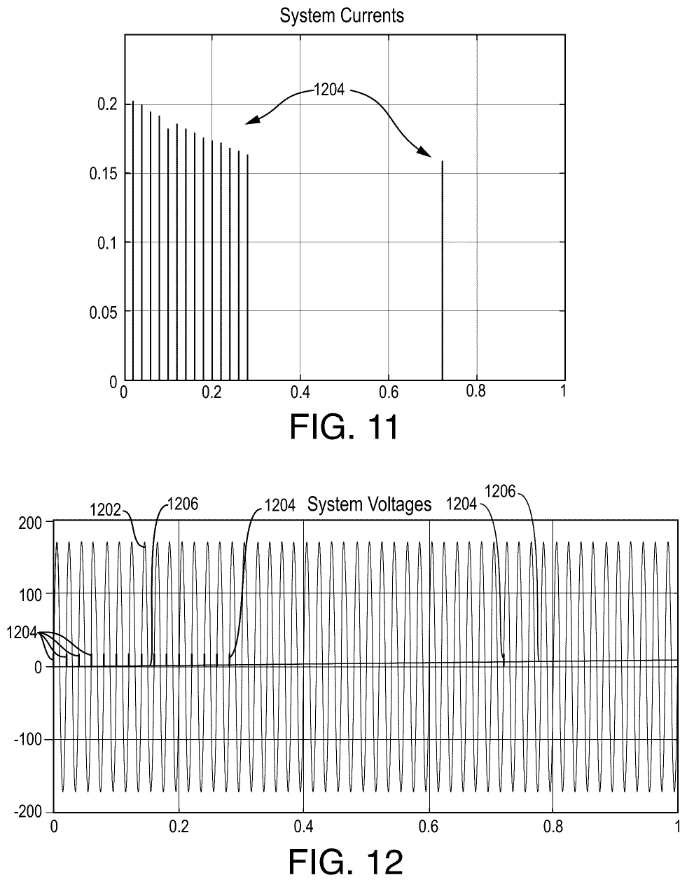

FIG. 11 shows current through the series switch 114 while the switch 102 is off.

FIG. 12 shows system voltage waveforms while the switch 102 is off. The blue waveform 1202 depicts the source voltage Vphase, the red “spikes” 1204 depict the capacitor 112 being charged when the source voltage Vphase voltage is a little higher than 5V, and the grey line 1206 shows the voltage on the capacitor 112. It takes several cycles to initially charge the capacitor 112 (as shown by the multiple consecutive red spikes and the capacitor voltage 1206 slowly increasing as the spikes 1204 consecutively occur), and then a “spike” 1204 on an occasional single cycle to maintain the charge.

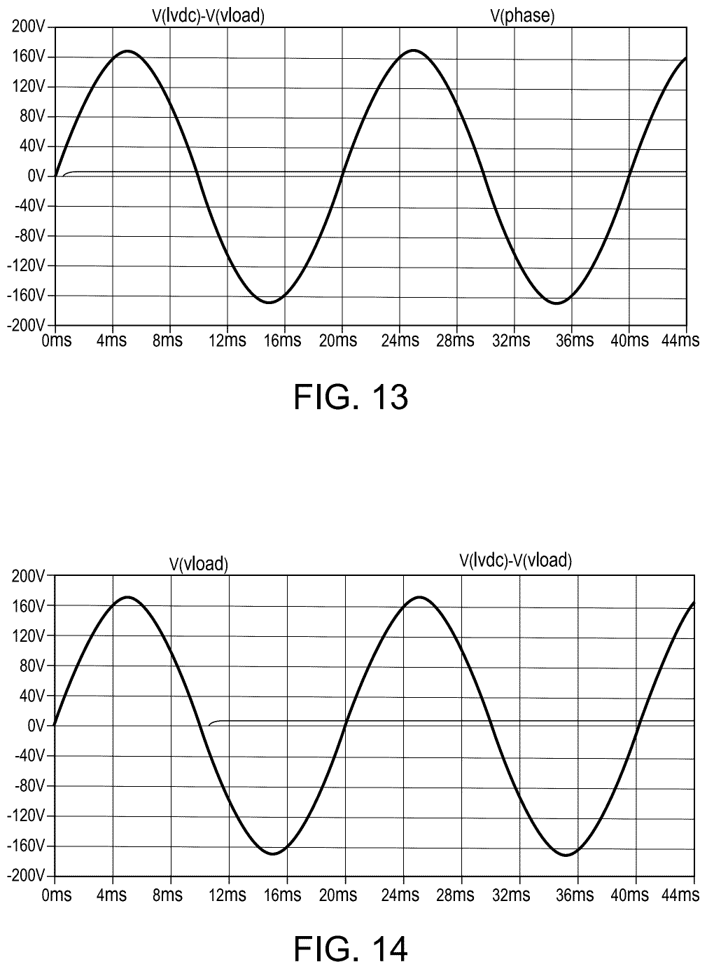

FIGS. 13 and 14 demonstrate waveforms associated with charging the capacitor 112 by energy harvesting in an example scenario with a neutral connection. FIG. 13 shows energy harvesting during the “off” state of the switch 102. The capacitor 112 is charged when the source voltage Vphase is a little higher than 5V. FIG. 14 shows energy harvesting during the “on” state of switch 102. The capacitor 112 is charged when the source voltage Vphase is a little lower than −5V.

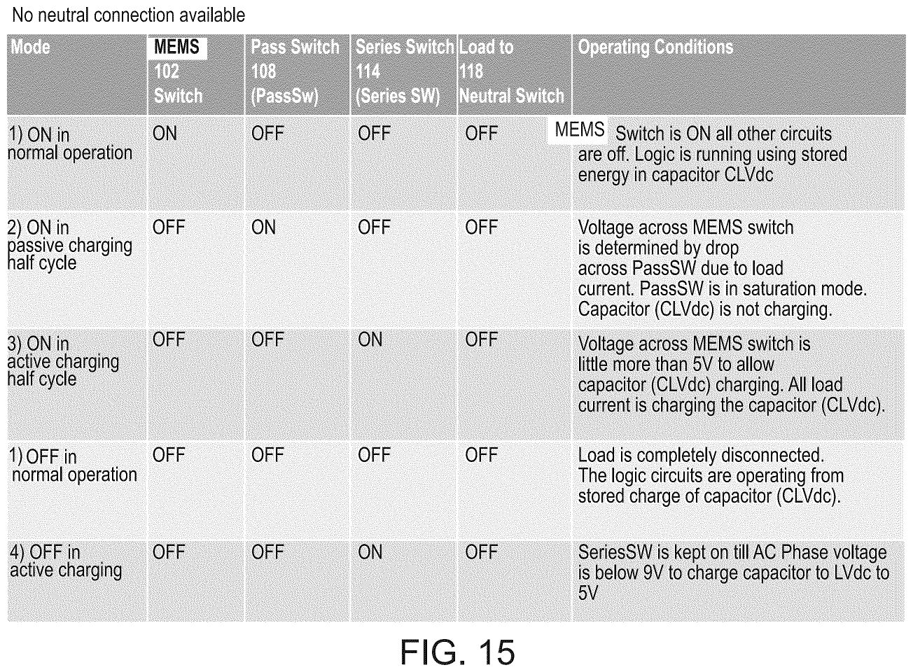

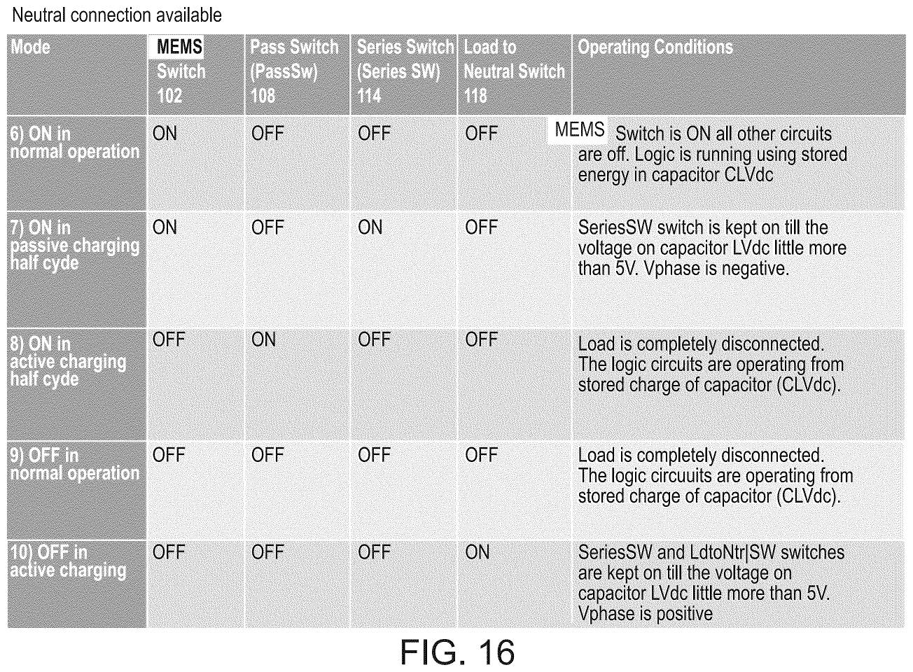

FIG. 15 depicts operational modes when the configuration does not have a neutral connection (e.g., as shown in FIG. 7). FIG. 16 depicts operational modes when the system configuration provides access to a neutral connection (e.g., as shown in FIGS. 6 and 8).

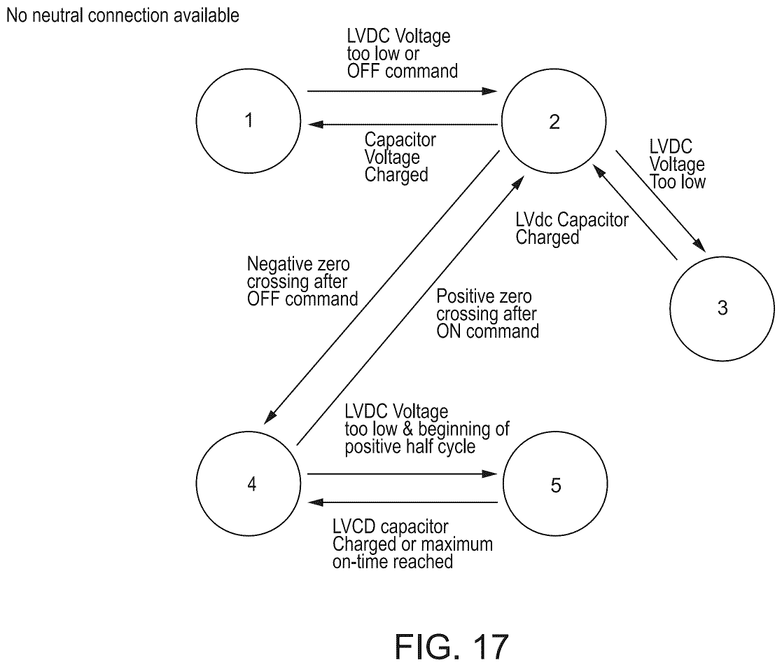

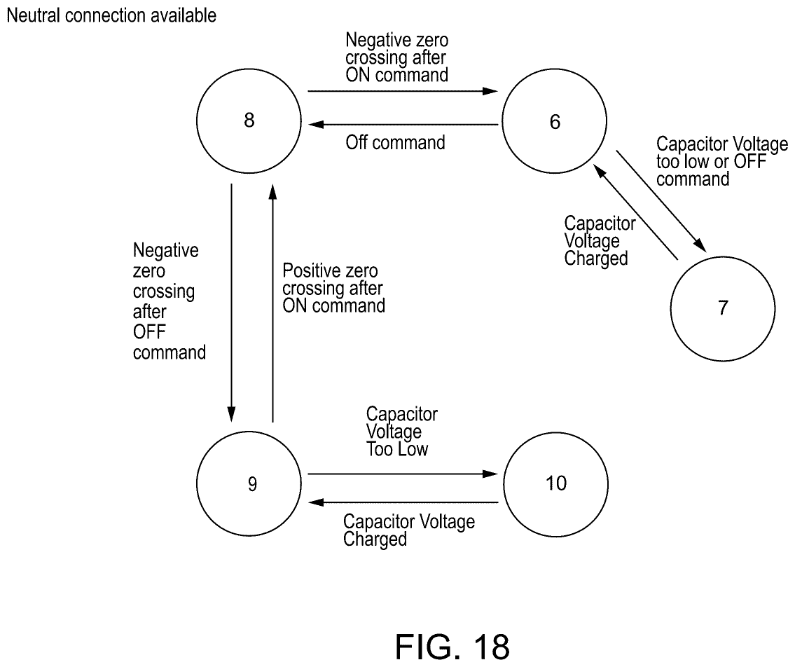

FIGS. 17 and 18 show state diagrams for configurations without a neutral connection available and with a neutral connection available, respectively.

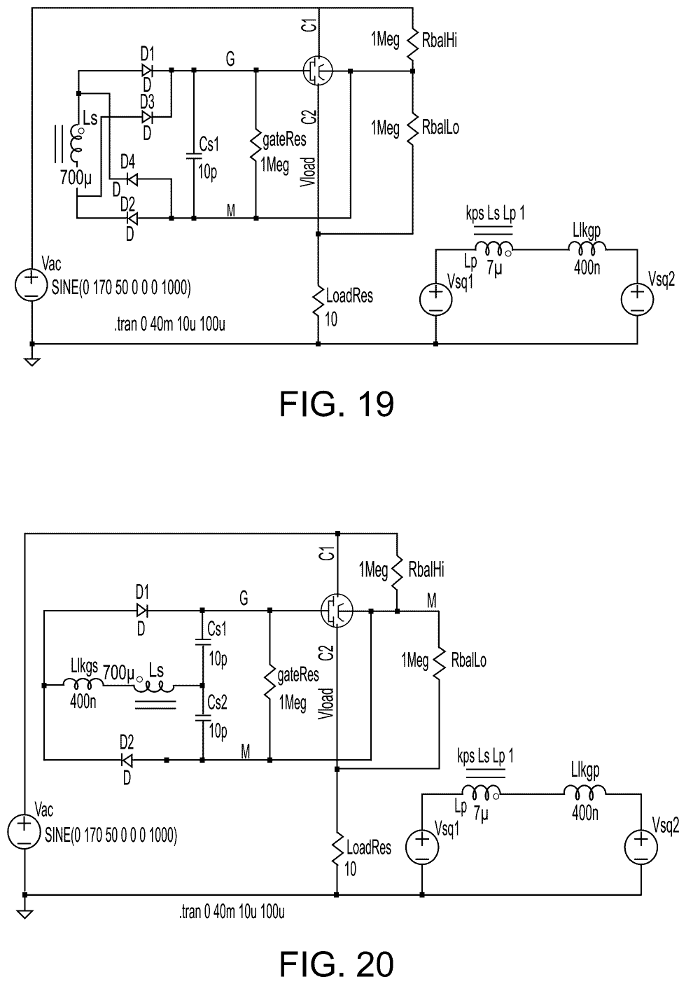

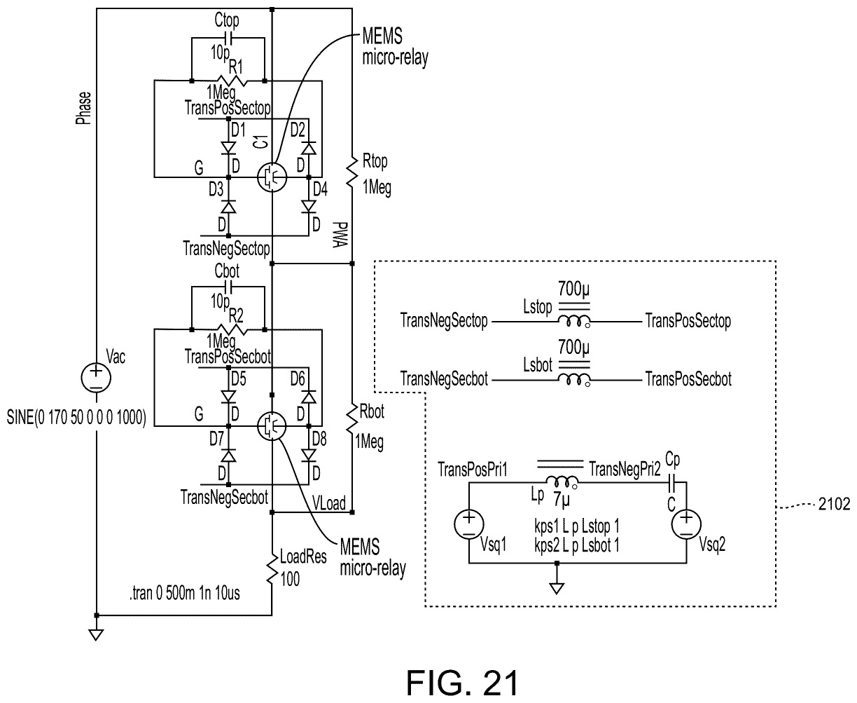

FIGS. 19 and 20 show example embodiments for gate drive circuits for driving the embodiment of the switch 102 implemented by a MEMS relay. FIG. 21 illustrates a gate drive circuit for driving an embodiment of the switch 102 implemented by a stacked MEMS micro-relay. Stacking of switches may be required when switching relatively high voltages. For example, a MEMS micro-relay may be able to handle a 110 VAC source, while trying to switch a a 220 VAC source may cause damage to the micro-relay. Stacking of MOSFET devices tend to be inefficient, while MEMS micro-relays perform well when stacked in series. In a stacked situation, both MEMS relays are arranged to commute simultaneously or nearly simultaneously. If the stacked switches do not switch simultaneously, the full voltage across the stack may be across just one of the relays, which may damage that relay.

The transformer 2102 in FIG. 21 has one primary winding and two secondary windings—one winding for the top relay and one winding for the bottom relay. In one embodiment, components except the transformer 2101, the MEMS device(s), the opto-isolator diode 126 and the other diodes (and possibly other larger capacitors/resistors surrounding the MEMS device) will be hosted on a single integrated circuit (IC). Accordingly, the high MEMS gate actuation voltages generated by the transformer will not be on the IC. Theoretically much higher voltages (e.g., 11 KV line) can be switched by series-stacking multiple switches, which may not be possible with a MOSFET stack.

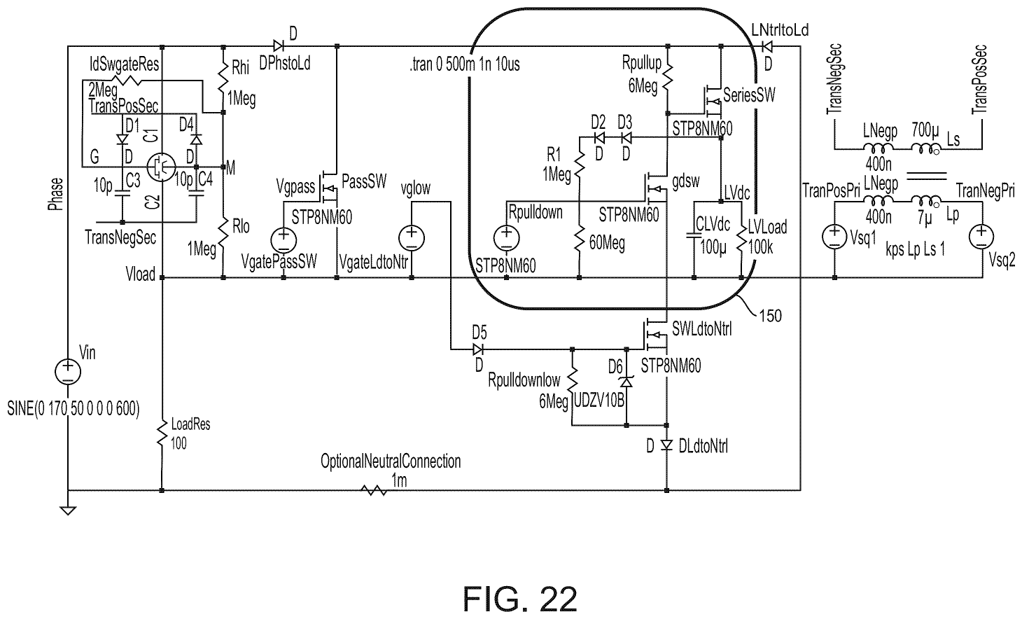

FIG. 22 illustrates a self-starting circuit 150, associated with the series switch 114, configured to initially provide power to logic and MEMS gate drive circuits upon system power-up. As explained in more detail herein, the capacitor 112 provides the voltage for powering the control logic that drives the bypass switch 108 and the series switch 114 (among others), but that logic and those switches are required to charge the capacitor 112. The self-starting circuit 150 facilitates initially charging the capacitor 112 when the system is first energized, before the primary charging control logic and switches are available.

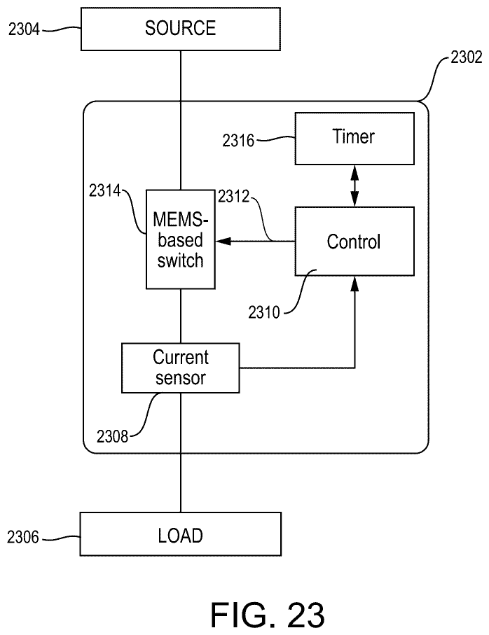

The described embodiments may operate as a smart fuse 2302 (i.e., a current interruption device) instead of or in addition to a smart switch, as shown in FIG. 23. A smart fuse 2303 is a two-terminal, breakable connection between the source 2304 and the load 2306 that doesn't just remain open until replaced or reset. A smart fuse 2302 may measure the current flowing through the smart fuse 2302 with a current sensor element 2308 and provide the current measurement to a control element 2310. The control element 2310 may sever the connection between the source and load by sending a control signal 2312 to a micro-relay 2314 (e.g., a MEMS-based switch) when that threshold is exceeded for a first predetermined amount of time. A timer 2316 may be used by the control element 2310 to determine elapsed time. The smart fuse 2302 may further reconnect the source and load, through the control signal 2312, once a second predetermined time expires. The first predetermined amount of time may or may not be equal to the second predetermined amount of time. The first and second predetermined amounts of time may be programmable by a user. An ordinary, prior art fuse has some non-trivial “on” resistance. That on resistance dissipates heat, which may be a small amount of heat, but over the life of the fuse the total amount is non-trivial, and further adds up over an array of fuses. The MEMS relay used in the described embodiments has a very low on-resistance, so it provides a savings of what would be wasted power when used over a large scale.

Another advantage to a smart fuse may be demonstrated by an example: suppose a sump pump in the basement of a home is equipped with an ordinary fuse. If that fuse blows, the home owner should be aware of it. If the homeowner is not aware, the next time a substantial storm occurs the basement may flood because the sump pump is not working. A smart fuse with wireless communications capability (e.g., BLE) can inform the homeowner if the fuse has blown or is blowing consistently, which may indicate a problem with the sump pump.

While example embodiments have been particularly shown and described, it will be understood by those skilled in the art that various changes in form and details may be made therein without departing from the scope of the embodiments encompassed by the appended claims.

What is claimed is:

1. A switch device, comprising:
a micro-relay disposed between a first terminal and a second terminal, the micro-relay selectively electrically couples the first terminal to the second terminal;
a bypass circuit that selectively diverts at least a portion of electrical current flowing from the first terminal to the micro-relay, and directs the diverted electrical current to the second terminal;
an energy harvesting circuit that (i) withdraws a portion of energy flowing into the switch device, (ii) stores the portion of energy in an energy storage device, and (iii) supplies the energy stored in the energy storage device to one or more components within the switch device.

2. The switch device of claim 1, wherein the first terminal may be coupled to a source of electrical current, and the second terminal may be coupled to a load that is a sink for electrical current.

3. The switch device of claim 1, further comprising a third terminal coupled to a neutral node associated with the source of electrical current and the load.

4. The switch device of claim 1, wherein a neutral switch may couple electrical current flowing from the micro-relay, away from the second terminal and to the third terminal.

5. The switch device of claim 1, further comprising a transformer that generates an actuating voltage for the micro-relay from the energy stored in the energy storage device.

6. The switch device of claim 1, wherein the micro-relay is a MEMS device.

7. The switch device of claim 1, further comprising a wireless transceiver that conveys control information into the switch device and/or test point and/or diagnostic information out of the switch device.

8. A current interruption device, comprising:
a micro-relay disposed between a first terminal and a second terminal, the micro-relay selectively electrically couples the first terminal to the second terminal;
a current measurement circuit that measures current flowing through the micro-relay and generates a current signal that is indicative of the current flowing through the micro-relay;
a control component that opens the micro-relay when the current signal indicates that the current flowing through the micro-relay exceeds a threshold current value for a first amount of time;
an energy harvesting circuit that (i) withdraws a portion of energy flowing into the current interruption device, (ii) stores the portion of energy in an energy storage device, and (iii) supplies the energy stored in the energy storage device to one or more components within the current interruption device.

9. The current interruption device of claim 8, wherein the first terminal may be coupled to a source of electrical current, and the second terminal may be coupled to a load that is a sink for electrical current.

10. The current interruption device of claim 8, further comprising a transformer that generates an actuating voltage for the micro-relay from the energy stored in the energy storage device.

11. The current interruption device of claim 8, further comprising a timer component that provides an indication of elapsed time to the control component, wherein the control component uses the indication of elapsed time to determine the threshold amount of time.

12. The current interruption device of claim 8, wherein the control component further closes the micro-relay when a second amount of time has passed.

13. The current interruption device of claim 8, wherein the first amount of time and the second amount of time is programmable by a user.

14. The current interruption device of claim 8, further comprising a wireless transceiver that conveys control information into the current interruption device and/or test point and/or diagnostic information out of the current interruption device.

15. A method of controlling a flow of current between a first terminal and a second terminal, comprising:
selectively electrically coupling, using a micro-relay, the first terminal to the second terminal;
selectively diverting, using a bypass circuit, at least a portion of electrical current flowing from the first terminal to the micro-relay, and directing the diverted electrical current to the second terminal;
using an energy harvesting circuit, (i) withdrawing a portion of energy flowing into the micro-relay, (ii) storing the portion of energy in an energy storage device, and (iii) supplying the energy stored in the energy storage device to one or more components associated with the micro-relay.

16. The method of claim 15, further comprising coupling, using a neutral switch, electrical current flowing from the micro-relay, away from the second terminal and to the third terminal.

17. The method of claim 15, further comprising conveying, with the use of a wireless transceiver, control information for operating the micro-relay and/or test point and/or diagnostic information associated with operation of the micro-relay.

18. A method of interrupting a flow of current between a first terminal and a second terminal, comprising:
selectively electrically coupling, using a micro-relay, the first terminal and the second terminal;
measuring, using a current measurement circuit, current flowing through the micro-relay, and generating a current signal that is indicative of the current flowing through the micro-relay;
opening, using a control component, the micro-relay when the current signal indicates that the current flowing through the micro-relay exceeds a threshold current value for a first amount of time;
using an energy harvesting circuit, (i) withdrawing a portion of energy flowing into the micro-relay, (ii) storing the portion of energy in an energy storage device, and (iii) supplying the energy stored in the energy storage device to one or more components associated with the micro-relay.

19. The method of claim 18, further comprising closing the micro-relay when a second amount of time has passed.

20. The method of claim 18, further comprising conveying, with the use of a wireless transceiver, control information for operating the micro-relay and/or test point and/or diagnostic information associated with operation of the micro-relay.
